(19) United States
(12) Patent Application Publication
(10) Pub. No.: US 2026/0342236 A1
(43) Pub. Date: Oct. 29, 2026

(54) HYBRID MODULATION AND CONTROL OF A CLLLC BIDIRECTIONAL DUAL DC-DC CONVERTER FOR ACTIVE BALANCING WITH SPLIT-BATTERY PACK CONFIGURATION IN ELECTRIC VEHICLE (EV) APPLICATIONS

(71) Applicant: Atieva, Inc., Newark, CA (US)

(72) Inventors: Sunil Kumar Dube, Newark, CA (US); John Kurian, Newark, CA (US); Sai Ram Abhishek Iruvanti, Newark, CA (US); Dung Anh Nguyen, Newark, CA (US); Shan Chai, Newark, CA (US); Yukun Luo, Newark, CA (US)

(21) Appl. No.: 19/193,727

(22) Filed: Apr. 29, 2025

(51) Int. Cl. H02M 3/335; B60L 53/22; H02J 7/02; H02M 1/00

(52) U.S. Cl. CPC H02M 3/33584; B60L 53/22; H02J 7/02; H02M 1/0058; B60L 2210/10; H02J 2207/20

(57) ABSTRACT

A dual DC-DC CLLLC bidirectional converter has a controller and two DC-DC CLLLC bidirectional converters, for connection to a low voltage (LV) battery and two high voltage (HV) packs of a split HV pack, for example in an electric vehicle. The controller enables, disables and operates the two converters with switch controls, power flow and power transfer direction, in multiple modes. These may include balancing one HV pack from the other HV pack, charging the LV battery from one or both HV packs, pre-charging an HV bus or HV capacitor from the LV battery, and further functions. The converter may regulate switching frequency and phase shift, use a unipolar voltage pulse on the HV side and a bipolar voltage pulse on the LV side, have zero voltage switching (ZVS), operate within a specified range of normalized frequency, decrease switching frequency for increased output power and/or have further technological improvements.

### TECHNICAL FIELD

The technical field of the present disclosure relates to DC-DC converters, more specifically DC-DC bidirectional converters, and still more specifically DC-DC bidirectional converters in electric vehicles.

### BACKGROUND

DC-DC converters may be used for transferring power from one battery to another, and particularly may be used in electric vehicles that have high voltage (HV) batteries and low voltage (LV) batteries, e.g., 12 V. DC-DC converters may be bidirectional, so that power can be transferred or flow from one battery to another and vice versa. CLLLC is one known topology for DC-DC converters. There is an ongoing need in DC-DC converter technology, and electric vehicle technology, for improvements in capabilities, performance and/or efficiency. It is in this environment that present embodiments arise.

### SUMMARY

Embodiments of a CLLLC bidirectional dual DC-DC converter, controllers and control thereof, including hybrid modulation of frequency and phase, are disclosed herein. One use for various embodiments is in electric vehicles, connected to a low voltage (LV) battery and a high voltage (HV) packs of a split HV pack. Various embodiments have technological improvements in capabilities, performance and/or efficiency.

One embodiment is a dual DC-DC CLLLC bidirectional converter. The converter includes a controller, a first DC-DC CLLLC bidirectional converter and a second DC-DC CLLLC bidirectional converter. The first DC-DC CLLLC bidirectional converter is connectable to a first high voltage (HV) pack of a split HV pack and connectable to a low voltage (LV) battery. The second DC-DC CLLLC bidirectional converter is connectable to a second HV pack of the split HV pack and connectable to the LV battery. The controller is to enable, disable, and operate each of the first DC-DC CLLLC bidirectional converter and the second DC-DC CLLLC bidirectional converter, with switch controls, power flow and power transfer direction, in multiple modes. The modes include balancing the second HV pack from the first HV pack through the first DC-DC CLLLC bidirectional converter and the second DC-DC CLLLC bidirectional converter. The modes include balancing the first HV pack from the second HV pack through the second DC-DC CLLLC bidirectional converter and the first DC-DC CLLLC bidirectional converter. The modes include charging the LV battery from the first HV pack through the first DC-DC CLLLC bidirectional converter, from the second HV pack through the second DC-DC CLLLC bidirectional converter, or from the first and second HV packs through the first and second DC-DC CLLLC bidirectional converters. The modes include pre-charging an HV bus or an HV capacitor from the LV battery through the first DC-DC CLLLC bidirectional converter, through the second DC-DC CLLLC bidirectional converter, or through the first and second DC-DC CLLLC bidirectional converters.

One embodiment is a method of operating a dual DC-DC CLLLC bidirectional converter. The method includes enabling, disabling, and operating each of a first DC-DC CLLLC bidirectional converter connected to a first high voltage (HV) pack of a split HV pack and connected to a low voltage (LV) battery, and a second DC-DC CLLLC bidirectional converter connected to a second HV pack of the split HV pack and connected to the LV battery. These actions are performed through a controller, with switch controls, power flow and power transfer direction. The method includes balancing the second HV pack from the first HV pack through the controller operating the first DC-DC CLLLC bidirectional converter and the second DC-DC CLLLC bidirectional converter. The method includes balancing the first HV pack from the second HV pack through the controller operating the second DC-DC CLLLC bidirectional converter and the first DC-DC CLLLC bidirectional converter. The method includes charging the LV battery from the first HV pack through the controller operating the first DC-DC CLLLC bidirectional converter, from the second HV pack through the controller operating the second DC-DC CLLLC bidirectional converter, or from the first and second HV packs through the controller operating the first and second DC-DC CLLLC bidirectional converters. The method includes pre-charging an HV bus or an HV capacitor from the LV battery through the controller operating the first DC-DC CLLLC bidirectional converter, through the controller operating the second DC-DC CLLLC bidirectional converter, or through the controller operating the first and second DC-DC CLLLC bidirectional converters.

One embodiment is a tangible, non-transitory, computer-readable media having instructions thereupon which, when executed by a processor, cause the processor to perform a method. The method includes enabling, disabling, and operating each of a first DC-DC CLLLC bidirectional converter, of a dual DC-DC CLLLC bidirectional converter, connected to a first high voltage (HV) pack of a split HV pack and connected to a low voltage (LV) battery, and a second DC-DC CLLLC bidirectional converter, of the dual DC-DC CLLLC bidirectional converter, connected to a second HV pack of the split HV pack and connected to the LV battery. These actions of the method are performed through a controller, with switch controls, power flow and power transfer direction. The method includes balancing the second HV pack from the first HV pack through the controller operating the first DC-DC CLLLC bidirectional converter and the second DC-DC CLLLC bidirectional converter. The method includes balancing the first HV pack from the second HV pack through the controller operating the second DC-DC CLLLC bidirectional converter and the first DC-DC CLLLC bidirectional converter. The method includes charging the LV battery from the first HV pack through the controller operating the first DC-DC CLLLC bidirectional converter, charging the LV battery from the second HV pack through the controller operating the second DC-DC CLLLC bidirectional converter, or charging the LV battery from the first and second HV packs through the controller operating the first and second DC-DC CLLLC bidirectional converters. The method includes pre-charging an HV bus or an HV capacitor from the LV battery through the controller operating the first DC-DC CLLLC bidirectional converter, through the controller operating the second DC-DC CLLLC bidirectional converter, or through the controller operating the first and second DC-DC CLLLC bidirectional converters. The method includes enabling and disabling, through the controller, each of the first and second DC-DC CLLLC bidirectional converters based on loading conditions.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A illustrates a DC-DC converter in an electric vehicle application with a high voltage (HV) battery and a low voltage (LV) battery.

FIG. 1B illustrates a Comparison of Efficiency Vs Output Power at HV Nominal Voltage: 370V, LV Voltage: 13.8V for different DC-DC Converters.

FIG. 2 illustrates the power flow at different scenarios of embodiments of the dual DC-DC converter in the split pack configuration.

FIG. 3 illustrates a schematic circuit diagram of an embodiment of the dual DC-DC converter system.

FIG. 4 illustrates an equivalent circuit diagram.

FIG. 5 illustrates a control loop architecture for embodiments.

FIG. 6 illustrates modulation and switching pulse generation for embodiments.

FIG. 7 illustrates modulation and switching pulse generation for HV to LV (Forward) and LV to HV (reverse) power flow, for embodiments.

FIG. 8 illustrates voltage gain curves and the range of operating frequency for embodiments.

FIG. 9 illustrates a switching frequency power curve, for an embodiment with ranges of HV Voltage: 295-430V, LV Voltage: 11-15V, and Output Power: 200-1250 W.

FIG. 10 illustrates a switching frequency power curve, for an embodiment with ranges of HV Voltage: 430-470V, LV Voltage: 11-15V, and Output Power: 200-1250 W.

FIG. 11 illustrates a dual DC-DC CLLLC bidirectional converter, in accordance with present embodiments.

FIG. 12 is a flow diagram illustrating a method of operation of a dual DC-DC CLLLC bidirectional converter, in accordance with present embodiments.

FIG. 13 illustrates some embodiments of a communication framework for use by an EV in communicating with an electric utility company in compliance with the electric utility interconnection requirements.

FIG. 14 is a high-level view of some embodiments of a vehicle 1000.

FIG. 15 is a high-level illustration of an exemplary computing device that can be used in accordance with the systems and methodologies disclosed herein.

### DETAILED DESCRIPTION

Embodiments of a dual DC-DC bidirectional converter, suitable for active balancing with a split-battery pack configuration in electric vehicle (EV) applications, and other uses, are described herein. Embodiments may have hybrid modulation and control, and may have a CLLLC (capacitor, inductor, inductor, inductor, capacitor) architecture. Some embodiments of the dual DC-DC converter have two CLLLC DC-DC converters, both connected to a low voltage (LV) battery on the secondary side of the converter, and each connected on the primary side of the converter to a respective pack of a split-pack high voltage (HV) battery. Embodiments can charge the LV battery from either or both HV packs through corresponding power transfer or power flow. Embodiments can charge one HV pack from the other HV pack, and vice versa, for battery balancing through corresponding power transfer or power flow. One purpose for some embodiments is to optimize the efficiency, reduce the cost, and have a narrower range of operating frequency for worst-case charge balancing, in various imbalance scenarios in a split-pack battery.

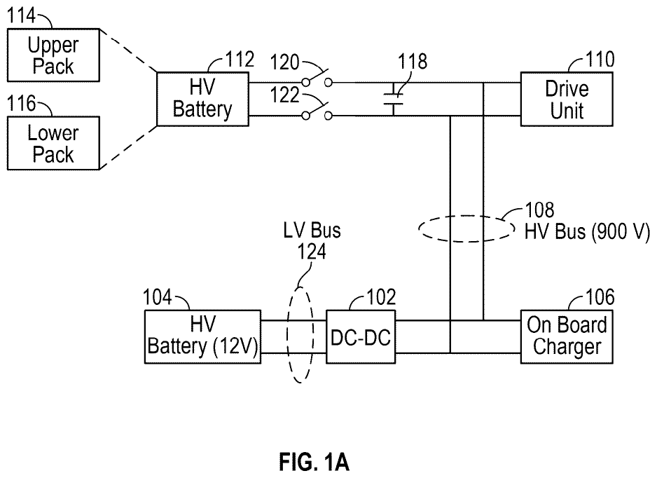

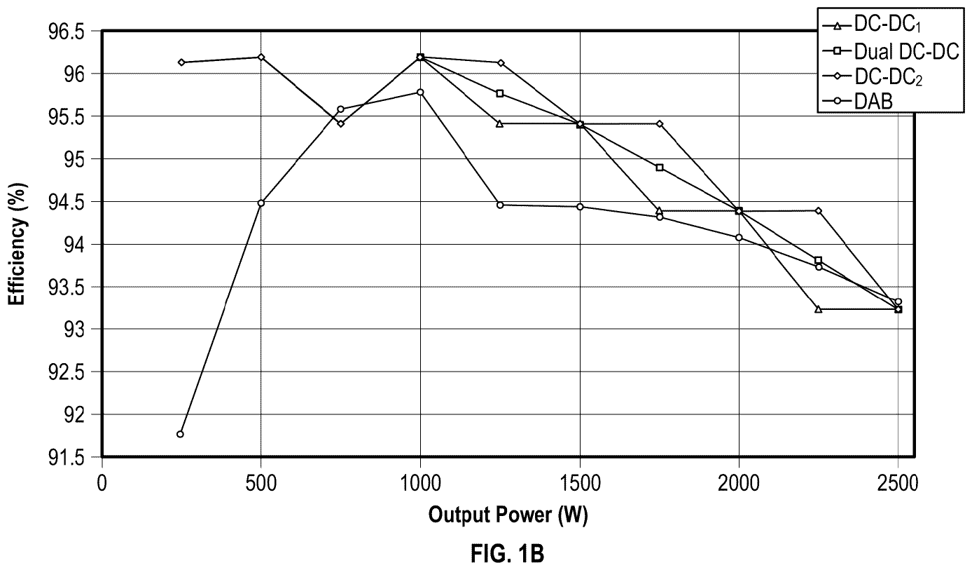

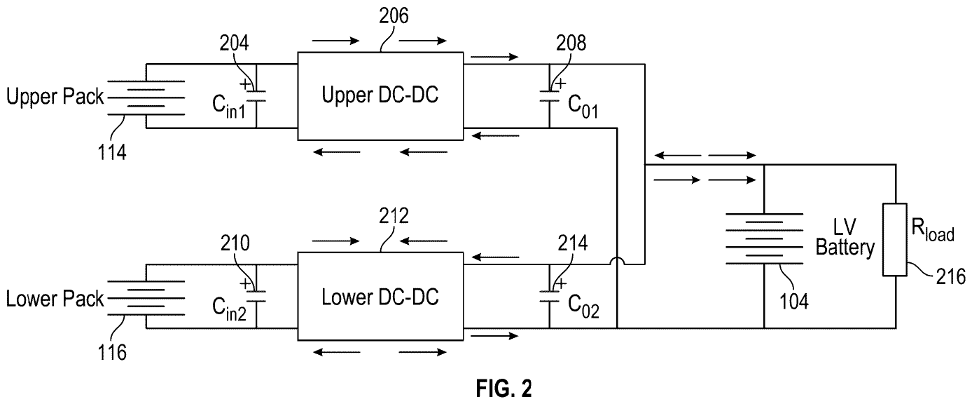

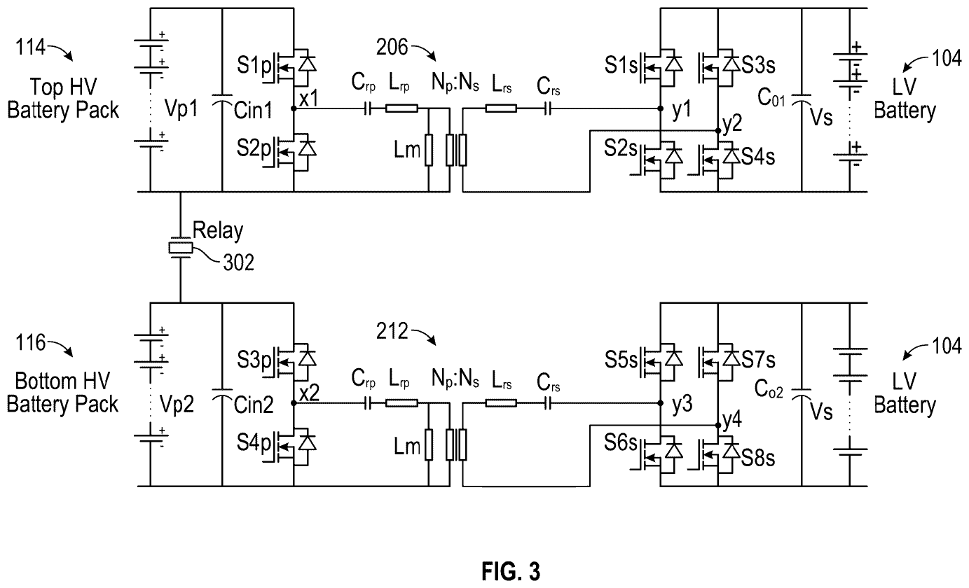

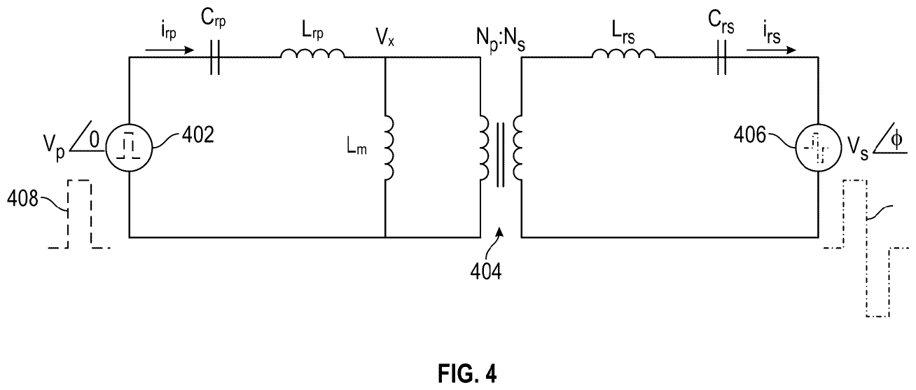

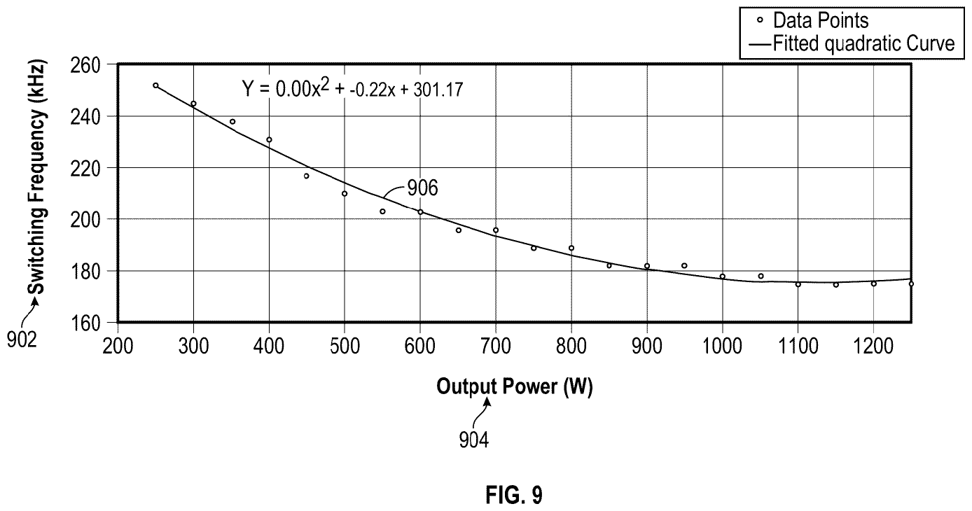

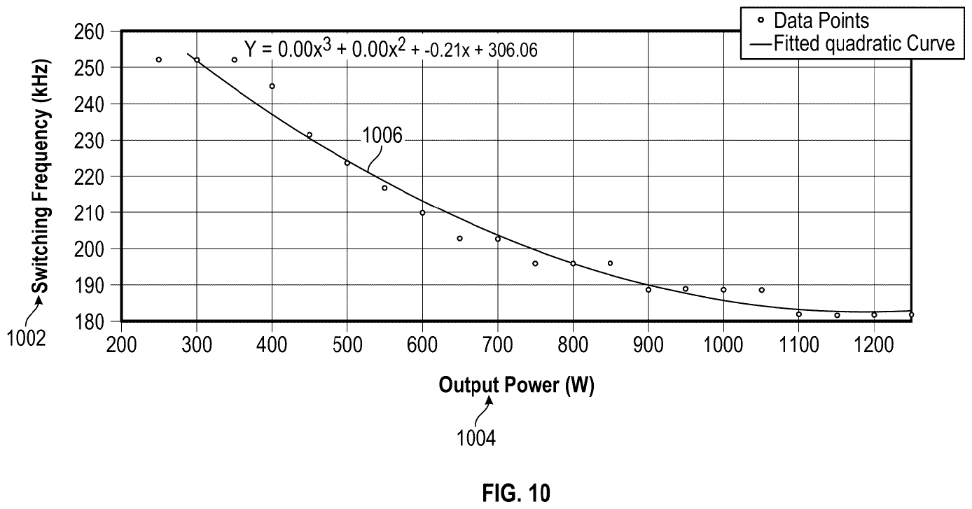

FIG. 1A illustrates a DC-DC converter in an electric vehicle application with a high voltage (HV) battery 112 and a low voltage (LV) battery 104. The HV battery 112 may be composed of an upper HV pack 114 and a lower HV pack 116, although this is not required for understanding the principles that apply more generally to HV batteries and electric vehicle systems as discussed in this section. In this illustration, the HV battery 112 can be connected and disconnected through switches 120, 122, to a high voltage (HV) bus 108, for example rated at 900 V DC. A high voltage capacitor 118 is connected across the HV bus 108. It is desirable to pre-charge the high voltage capacitor 118 prior to connecting the HV battery 112 to the HV bus 108, to protect the switches 120, 122 from surge current damage (e.g., exceeding the current rating of the switches 120, 122). The HV bus 108 is connected to the drive unit 110, for electric propulsion of the electric vehicle. An onboard charger 106 is connected to the HV bus 108, for charging the HV battery 112 as may be done by plugging the onboard charger 106 into an appropriate socket for a power source. The LV battery 104, for example a 12 V automotive battery, is connected to the DC-DC converter 102, which is connected to the HV bus 108. The onboard charger 106 may thus charge the LV battery 104, using power transfer through the DC-DC converter 102. And, since in this example the DC-DC converter 102 is bidirectional, the LV battery 104 can pre-charge the HV bus 108 and HV capacitor 118, through power transfer through the DC-DC converter 102. Also, the HV battery 112 can charge the LV battery 104 through the DC-DC converter 102. What FIG. 1A does not show, and where presently described embodiments have a technological improvement and advantage, is how a DC-DC converter 102 could be used for balancing the upper pack 114 or the lower pack 116, from the other of the two packs, in the HV battery 112. This and further technological improvements are described below, with reference to FIG. 2 for architecture, power flow and power transfer, FIG. 3 for architecture and circuitry, FIGS. 4-8 for control, timing, signals and waveforms, and FIGS. 9-10 for output power and switching frequency analysis. The drawings are collectively described below for an overview of embodiments, followed by individual drawing description for deeper understanding.

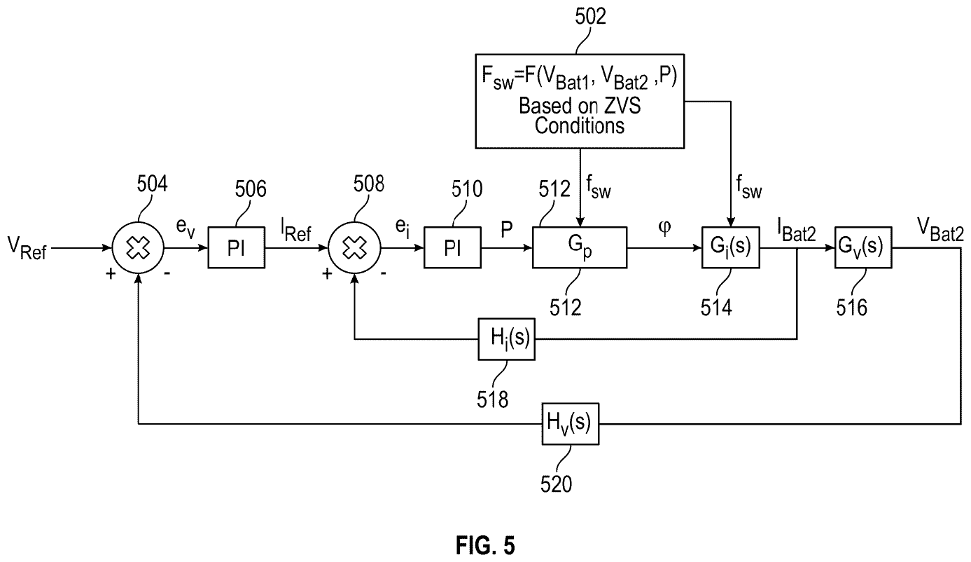

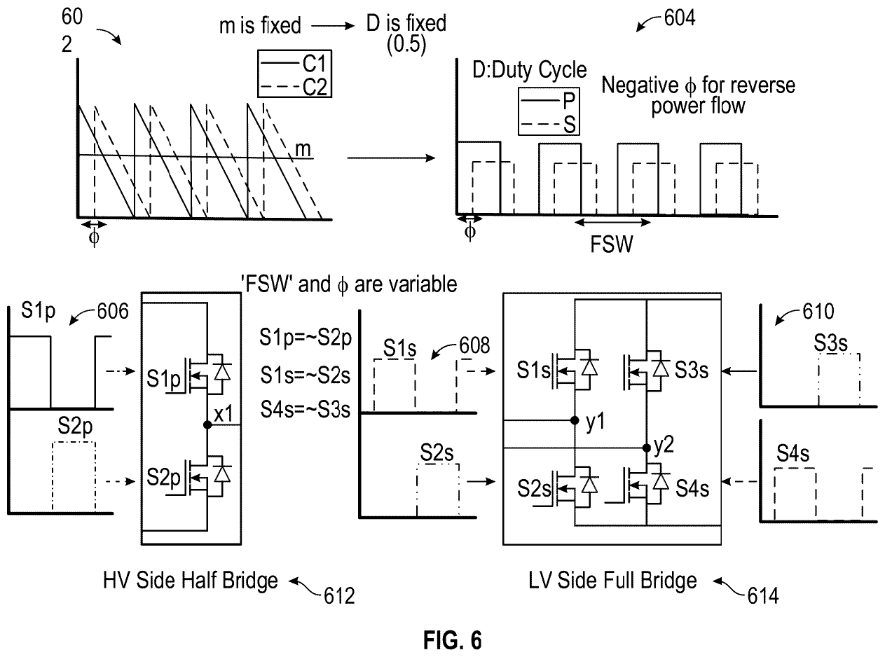

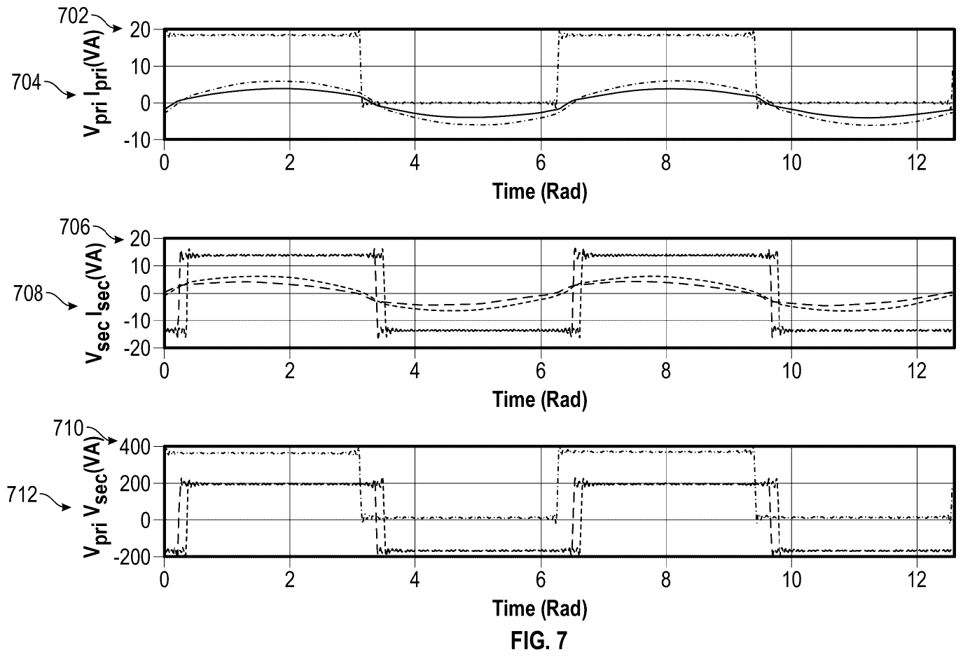

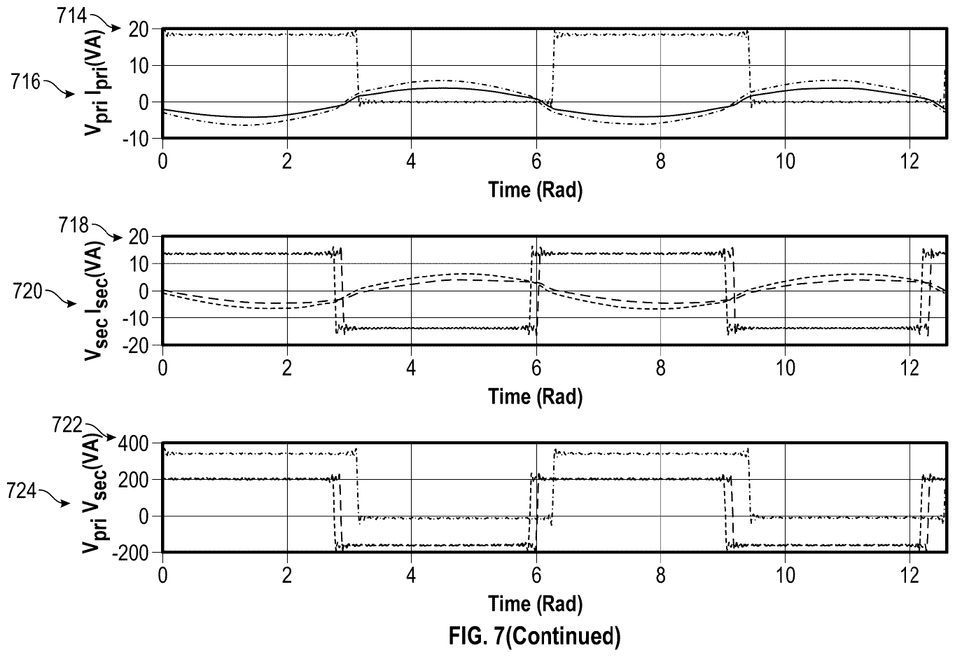

Embodiments described herein provide a hybrid modulation and control of a Dual DC-DC Bidirectional Converter connected across a split-battery pack. Here, the HV side of the converter has a half-bridge configuration and the LV side of the converter is in full-bridge configuration as shown in FIG. 3. The duty cycle of the both the HV and LV side devices are kept at 0.5, as shown in FIG. 4 (LV or secondary side), FIG. 6 and FIG. 7 (HV or primary side and LV or secondary side). By doing this, a unipolar voltage pulse 408 is generated across the HV side resonant tank (see FIG. 4), and a bipolar voltage pulse 410 is formed across the LV side (see FIG. 4). The power flow from HV to LV and vice-versa (see FIG. 2) is controlled by phase shift (see FIGS. 6 and 7). To have a Zero Voltage Switching (ZVS) turn-on across all the devices, the switching frequency of the semiconductor devices is regulated and proportionally the phase-shift is regulated (see FIG. 5 for control architecture and FIGS. 6-8 for timing, signals and waveforms) to achieve the required power transfer (see FIGS. 9 and 10). One dual DC-DC converter embodiment has two CLLLC DC-DC converters 206, 212 (see FIGS. 2 and 3) connected to each pack in a split-pack configuration. These two DC-DC converters 206, 212 are used for charging the 12V bus, e.g., LV bus 124 (see FIG. 1A), pre-charging the HV bus capacitor 118 (see FIG. 1A), and for voltage balancing of split-pack configurations (see FIGS. 1A, 2, 3) during different operating scenarios. A block diagram depicting the different operating conditions is shown in FIG. 2.

Various embodiments may have some or all of the following advantages. A hybrid modulation approach has both phase shift and frequency control to optimize the DC-DC converter design for high efficiency and narrower frequency range of operation while the converter operates with wide variation in voltages and currents at High Voltage (HV) and Low Voltage (LV) sides. Control architecture, in FIG. 5, timing, signals and waveforms, in FIGS. 6-8, are shown to guide implementation of embodiments that have the hybrid modulation approach.

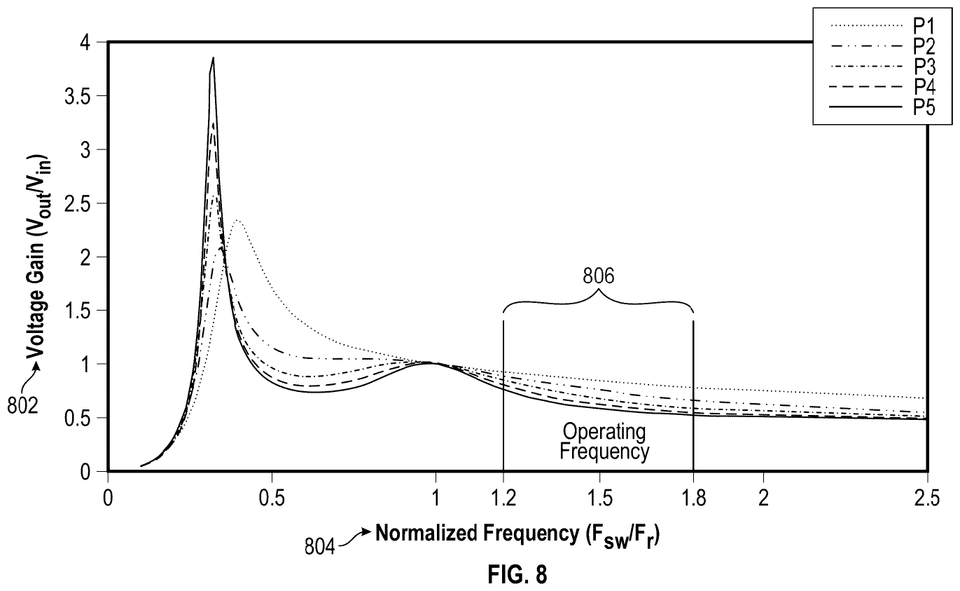

Narrower range of operating frequency helps in size reduction and better utilization of magnetic components. This simplifies the control of the DC-DC converter system operating with wide variation in voltages and currents at High Voltage (HV) and Low Voltage (LV) sides. Suitable range of operating frequency and effects of operating frequency on voltage gain, in FIG. 8, and effects of switching frequency on output power, in FIGS. 9 and 10, are shown to guide implementation of embodiments that have a narrower range of operating frequency.

HV side unipolar switching modulation and LV side bipolar switching modulation helps in elimination of two devices at the HV side leading to reduce cost of device, driver circuits and auxiliary power supplies. This results in Reduced Auxiliary Power Loss. Examples of circuitry and circuit elements with such architecture are shown in FIG. 3 to guide implementation of embodiments.

The dual DC-DC converter does worst-case charge balancing for a 15% imbalance during split-pack configuration in ~2 hours, in one embodiment, which thus reduces the passive balancing cost and energy waste. An example analysis is shown in Table. 1 for different operating conditions. The lifetime total energy cost saving in one example is estimated to be $175.

Systematic power sharing between each converter in an example dual DC-DC converter at different operating points optimizes the overall efficiency of the converter system. The different operating efficiencies during the power sharing across different loading condition is shown in FIG. 1B. This is shown to guide implementation of embodiments, particularly as to selection of type of converter, and operation of individual converters in a dual converter embodiment.

FIG. 1B illustrates a Comparison of Efficiency Vs Output Power at HV Nominal Voltage: 370V, LV Voltage: 13.8V for different DC-DC Converters. For the comparison, one embodiment is a dual DC-DC converter, which has a top or upper DC-DC converter 206 (see FIGS. 2 and 3) connected to one HV pack, e.g., upper or top HV pack 114 of the HV battery 112 (see FIGS. 1A, 2 and 3), and a bottom or lower DC-DC converter 212 (see FIGS. 2 and 3) connected to the other HV pack, e.g., lower or bottom HV pack 116 of the HV battery 112 (see FIGS. 1A, 2 and 3). One or both converters may be in operation, at a given time or output power level. One embodiment for the comparison is a Dual Active Bridge (DAB) converter. In this example, there is an imbalance in the HV packs, which shows as a difference in operating efficiency between the two converters at some levels of output power.

The output power trace 134 labeled “DC-DC1” illustrates output power with only the top DC-DC converter 206 in operation. A drop in efficiency is noted at some levels of output power, likely due to imbalance in the HV packs.

The output power trace 136 labeled “DC-DC2” illustrates output power with only the bottom DC-DC converter 212 in operation. Higher efficiency is noted at some levels of output power, in comparison to output power trace 134 of top DC-DC converter 206, likely due to imbalance in the HV packs.

The output power trace 132 labeled “Dual DC-DC” illustrates output power with both the top and bottom DC-DC converters 206, 212 in operation. Efficiency approximately averaging between the two converters 206, 212 is noted at some levels of output power, and this efficiency is less than optimal, likely due to imbalance in the HV packs. The take away finding here is that balancing the HV 370

acks could improve efficiency of dual converter operation. Also, operation of one converter could be selected, if output power level is sufficient for a given power requirement and efficiency improvement is appropriate.

The output power trace 138 labeled “DAB” illustrates output power with only one DAB converter in operation. The take away finding here is that individual DC-DC converter operation, and combined dual DC-DC converter operation, have greater efficiency or approximately equal efficiency to the DAB converter, especially if there is battery balancing in the HV packs. This supports that overall system efficiency is improved through the use of selective DC-DC converter operation in the dual DC-DC converter, and/or battery balancing of HV packs as may be accomplished using embodiments described herein, in comparison to the DAB converter.

The below table summarizes power levels of the two DC-DC converters, for which efficiency is analyzed and shown in FIG. 1B.

| | DC-DC1 | DC-DC2 |
|---|---|---|
| Power (W) | Power (W) | Power (W) |
| 250 | 250 | not in operation |
| 500 | 500 | not in operation |
| 750 | 750 | not in operation |
| 1000 | 500 | 500 |
| 1250 | 750 | 250 |
| 1500 | 750 | 750 |
| 1750 | 1000 | 750 |
| 2000 | 1000 | 1000 |
| 2250 | 1250 | 1000 |
| 2500 | 1250 | 1250 |

The following table shows various scenarios for balancing, to improve system efficiency. Some embodiments are estimated to perform balancing of an imbalanced HV pack, i.e., one of two HV packs in an HV battery, in approximately 2-4 hours, to balance a 15% imbalance.

TABLE 1
Active balancing at different scenarios for a split-pack configuration

| | Active | | Estimated | Hours to | Per hour active |
|---|---|---|---|---|---|
| | Balancing | Estimated | Active Bal | Balance | balancing rate |
| Scenario | Power (kW) | Load (kW) | Power (kW) | 15% imbalance | (% balanced/hr) |
| Vehicle Powered off | 2.5 kW - | cd0 | 2.5 | 2.19 | 6.85 |
| and HV battery | Load | | | | |
| disconnected from rest | | | | | |
| of the powertrain | | | | | |
| Vehicle Powered ON | 2.5 kW - | 1 | 1.5 | 3.65 | 4.11 |
| and Driving | Load | | | | |
| Vehicle Powered ON | 2.5 kW - | 1 | 1.5 | 3.65 | 4.11 |
| and Parked | Load | | | | |
| Vehicle performing AC | 2.5 kW - | 0.6 | 1.9 | 2.88 | 5.21 |
| charging | Load | | | | |
| Vehicle performing | 2.5 kW - | 1 | 1.5 | 3.65 | 4.11 |
| 800 V DCFC | Load | | | | |

FIG. 2 illustrates the power flow at different scenarios of embodiments of the dual DC-DC converter in the split pack configuration. In these embodiments, the upper DC-DC converter 206 of the dual DC-DC converter is coupled on the primary side of the converter to the upper HV pack 114 of the split pack HV battery, and coupled on the secondary side of the converter to the LV battery 104. The lower DC-DC converter 212 of the dual DC-DC converter is coupled on the primary side of the converter to the lower HV pack 116 of the split pack HV battery, and coupled on the secondary side of the converter to the same LV battery 104. Upper HV pack 114 and/or the primary side of the upper DC-DC converter 206 has a parallel connected input capacitor 204 labeled “Cᵢₙ₁”. Lower HV pack 116 and/or the primary side of the lower DC-DC converter 212 has a parallel connected input capacitor 210 labeled “Cᵢₙ₂”. The secondary side of the upper DC-DC converter 206 has an output capacitor 208 labeled “Cₒ₁”. The secondary side of the lower DC-DC converter 212 has an output capacitor 214 labeled “Cₒ₂”. And, the LV battery 104 has a parallel connected resistive load 216 labeled “R_{load}”, representing or modeling current drain on the LV battery 104, such as automotive components with passive power draw. The various arrows in the drawing illustrate flexible capabilities for power flow as directed in the system through control of the two converters, in various embodiments. For example, power flow may be directed from the upper pack 114 through the upper DC-DC converter 206 to the LV battery 104, to charge the LV battery 104 periodically and avoid a dead battery from passive power draw. Similarly, power flow may be directed from the lower pack 116 through the lower DC-DC converter 212 to the LV battery 104, to charge the LV battery 104 periodically and avoid a dead battery from passive power draw. Power flow control could take note of whether there is an imbalance in the HV split pack, and select one of the converters 206, 212 for operation and the other for non-operation or idle, to charge the LV battery 104 while discharging only one of the HV packs of the HV split pack.

For example, power flow may be directed from the upper pack 114 through the upper DC-DC converter 206 and through the lower DC-DC converter 212 to the lower pack 116, to balance the lower pack 116. Power flow may be directed from the lower pack 116 through the lower DC-DC converter 212 and through the upper DC-DC converter 206 to the upper pack 114, to balance the upper pack 114.

For example, power flow may be directed from the LV battery 104, or the LV bus 124 (see FIG. 1A), through the upper DC-DC charger 206 to precharge the high voltage input capacitor 204. Power flow may be directed from the LV battery 104, or the LV bus 124 (see FIG. 1A), through the lower DC-DC charger 212 to precharge the high voltage input capacitor 210. Power flow may be directed from the LV battery 104, or the LV bus 124 (see FIG. 1A), through the upper DC-DC charger 206 and/or the lower DC-DC charger 212 (in various embodiments, may depend on system connections) to precharge the HV bus 108 and/or high voltage capacitor 118 (see FIG. 1A).

Further power flows, directions and system operation directed thereto are understood in FIG. 2, for charging, discharging, balancing, pre-charging, etc. It is further understood a processor, for example a controller, may direct system operation and is readily developed in keeping with the teachings herein, although not explicitly shown in the drawings.

FIG. 3 illustrates a schematic circuit diagram of an embodiment of the dual DC-DC converter system. More specifically, the embodiment illustrated is a dual DC-DC CLLLC bidirectional converter. Related to FIG. 2, these embodiments show the circuitry and components, of an upper DC-DC CLLLC converter 206 coupled on the primary side to the upper or top HV battery pack 114 and coupled on the secondary side to the LV battery 104, and a lower DC-DC CLLLC converter 212 coupled on the primary side to the lower or bottom HV battery pack 114 and coupled on the secondary side to the same LV battery 104. It should be noted that the LV battery 104 is shown in duplicate in the drawing, which could apply to embodiments having multiple LV batteries 104, but multiple embodiments have really just the one LV battery 104 in the vehicle system.

On the primary side in each converter 206, 212, there are two switches in half-bridge configuration, e.g., S1p and S2p primary side switches for the upper converter 206, and S3p and S4p primary side switches for the lower converter 212. On the secondary side in each converter 206, 212, there are four switches in full-bridge configuration, e.g., S1s, S2s, S3s, S4s secondary side switches for the upper converter 206 and S5s, S6s, S7s, S8s secondary side switches for the lower converter 212.

Each converter 206, 212 has a transformer with primary side to secondary side turns ratio Np:Ns. The circuits are tuned for resonance and a resonant frequency corresponding to capacitor and inductor resonance, with primary side resonant capacitor inductor pair Crp, Lp with inductor Lm, and secondary side resonant inductor capacitor pair Lrs, Crs. These components affect frequency response and power transfer of the converters 206, 212, as further detailed with reference to FIGS. 8-10.

Operation of the switches, herein shown as MOSFETs, is further described below. It is understood such switch operation directs and causes power flow, as illustrated with reference to FIG. 2. Harmonic analysis, with fundamental frequency and harmonic frequencies, is applied herein. To aid in analysis, an equivalent circuit diagram to the converter is developed.

FIG. 4 illustrates an equivalent circuit diagram. This circuit diagram represents each converter 202, 212 of a dual DC-DC CLLLC bidirectional converter as illustrated in FIG. 3. A primary side signal generator 402 generates a unipolar voltage pulse 408, which has primary side voltage Vₚ at phase angle zero and current iᵣₚ, and is expressed on the HV side across the primary side resonant tank that includes the primary side of the transformer 404. A secondary side signal generator 406 generates a bipolar voltage pulse 410, which has secondary side voltage Vₛ at phase angle φ and current iᵣₛ, and is expressed on the LV side resonant tank that includes the secondary side of the transformer 404.

Power is transferred according to operation of the converter. The control variables for power transfer are phase angle φ and switching frequency f_{sw}. These are to be applied in controlling the switches of the converter.

The primary and secondary side bridge voltages are represented as follows,

$$Vbrp = {\sum }_{h = I}^{20} \frac{( 1 - cos ( 2 * π * Dp ) + i * sin ( 2 * h * π * Dp ) )}{\sqrt{2} h π}$$

$$Vbrs = {\sum }_{h = I}^{20} 2 V s \frac{( 1 - cos ( 2 * π * Ds ) + i * sin ( 2 * h * π * Ds ) )}{\sqrt{2} h π}$$

$$Xmh = h wLm$$

$$w = 2 π fsw$$

$$Xph = XLrph - jXCrph$$

$$Xsh = X L rsh - jXCrsh$$

$$XLrph = hwLrp$$

$$XLrsh = {hwLrp ( \frac{Np}{Ns} )}^{2}$$

$$h = harmonic number$$

$$XCrph = \frac{1}{hwCrp}$$

$$XCrsh = \frac{1}{hwCrp} {( \frac{Np}{Ns} )}^{2}$$

$$P 1 = \frac{Vp 1 * Vs 1}{Z e q} sin ϕ$$

$$Zeq = Xp 1 + Xs 1 + \frac{Xp 1 * Xs 1}{Xm 1}$$

$$ϕ = phase shift between Vbrp and Vbrs$$

$${P}_{total} = P 1 + P 3 + P 5 + P 7 + - - -$$

Power transfer based on harmonics is as follows, P1=power transfer due to fundamental switching, P3=power transfer due to 3^{rd} harmonic, P5=power transfer due to 5^{th} harmonic, P7=power transfer due to 7^{th} harmonic.

FIG. 5 illustrates a control loop architecture for embodiments. Embodiments of the control loop architecture are readily developed for switch control of the converter, more specifically control of the switches of the upper DC-DC converter 206 and lower DC-DC converter 212 of the dual DC-D's C CLLLC bidirectional converter. For example, an embodiment of this control loop architecture may be developed using a specially programmed processor or controller, using software executing on a processor, firmware, hardware, or combinations thereof. The control loop receives an input reference voltage V_{ref}, determines a switching frequency f_{sw}, and, using an inner loop for current and an outer loop for voltage, determines a phase shift φ. These control parameters are then used for generation of switch controls, for example signals and waveforms as shown in FIGS. 4, 6 and 7.

Continuing with FIG. 5, the control loop calculates or otherwise determines an error voltage eᵥ, from the outer loop summer 504 that sums the reference voltage V_{ref} and a feedback in the outer loop, from outer loop feedback conditioner 520. Feedback conditioner 520 performs a function Hᵥ(s) on the battery voltage V_{bat2}, which is the output from the outer loop.

A PI (proportional integral) controller 506 derives a reference current I_{ref}, for example by integrating the time value of the error voltage eᵥ and scaling, or integrating a scaled value of the error voltage. The reference current I_{ref} is input to the inner loop summer 508, which sums this and a feedback in the inner loop, from inner loop feedback conditioner 518. Inner loop feedback conditioner 518 performs a function Hᵢ(s) on the battery current I_{bat2}, which is the output from the inner loop. Output of the inner loop summer 508 is an error current, eᵢ.

Another PI (proportional integral) controller 510 derives power P, for example by integrating the time value of the error current, eᵢ and scaling, or integrating a scaled value of the error current. Power P and switching frequency f_{sw} are input to a phase shift determiner 512, which applies a function Gp to determine phase shift φ.

Switching frequency f_{sw} is from switch frequency determiner 502, which performs a function=f (V_{bat1}, V_{bat2}, P) based on ZVS (zero voltage switching) conditions. Switching frequency f_{sw} is also input with phase shift φ to battery current determiner 514, which operates on these inputs with a function Gᵢ(s) to produce battery current I_{bat2}, the output of the inner loop. Battery current I_{bat2} is input to battery voltage determiner 516, which operates on this input with a function Gᵥ(s) to produce battery voltage V_{bat2}, the output of the outer loop.

FIG. 6 illustrates modulation and switching pulse generation for embodiments. Switching frequency F_{sw} and phase shift or phase angle φ are variable.

Capacitor voltages 602 at C1 and C2 appear as vertical rise and diagonal fall triangle waves shifted by shift or phase angle φ, centered on horizontal line m, which is fixed. Duty cycle D is fixed (0.5). From these are derived primary and secondary pulses 604, which appear at the switching frequency F_{sw} and with the phase shift or phase angle φ separating them.

From these are derived HV side or primary side switching pulses 606, for S1p and S2p switches of the HV side half bridge 612. Also from these are derived LV side or secondary side switching pulses 608, 610, for S1s, S2s, S3s, S4s switches respectively of the LV side full bridge 614. Note that a negative phase shift or phase angle φ is used for reverse power flow.

FIG. 7 illustrates modulation and switching pulse generation for HV to LV (Forward) and LV to HV (reverse) power flow, for embodiments. Current and voltage waveforms are shown for primary and secondary sides of the converter, as follows.

Primary side current 702 labeled Iₚᵣᵢ(VA) is shown with primary side voltage 704 labeled Vₚᵣᵢ (two waveforms).

Secondary side current 706 labeled I_{sec}(VA) (two waveforms) is shown with secondary side voltage labeled V_{sec} (two waveforms).

Secondary side voltage 710 labeled V_{sec}(VV) is shown with primary side voltage 712 labeled Vₚᵣᵢ (two waveforms).

Primary side current 714 labeled Iₚᵣᵢ(VA) is shown with primary side voltage 716 labeled Vₚᵣᵢ (two waveforms).

Secondary side current 718 labeled I_{sec}(VA) (two waveforms) is shown with secondary side voltage 720 labeled V_{sec} (two waveforms).

Secondary side voltage 722 labeled V_{sec}(VV) is shown with primary side voltage 724 labeled Vₚᵣᵢ (two waveforms).

FIG. 8 illustrates voltage gain curves and the range of operating frequency for embodiments. On the vertical axis, voltage gain 802 is represented for output voltage over input voltage, Vout/Vin. On the horizontal axis, normalized frequency 804 is represented for switching frequency over resonant frequency, Fsw/Fr. The voltage gain curves are shown 45 power levels, P1, P2, P3, P4, P5. An operating frequency range 806 is shown, for normalized frequency 1.2-1.8, where the voltage gain curves are well behaved or have other desirable characteristic. Various embodiments employ such an operating frequency range 806.

FIG. 9 illustrates a switching frequency power curve 906, for an embodiment with ranges of HV Voltage: 295-430V, LV Voltage: 11-15V, and Output Power: 200-1250 W. On the vertical axis, switching frequency 902 is represented. On the horizontal axis, output power 904 is represented. The switching frequency power curve 906 is a fitted quadratic curve two data points, showing increasing output power for decreasing switching frequency, and switching frequency range for output power range.

FIG. 10 illustrates a switching frequency power curve 1006, for an embodiment with ranges of HV Voltage: 430-470V, LV Voltage: 11-15V, and Output Power: 200-1250 W. On the vertical axis, switching frequency 1002 is represented. On the horizontal axis, output power 1004 is represented. The switching frequency power curve 1006 is a fitted quadratic curve two data points, showing increasing output power for decreasing switching frequency, and switching frequency range for output power range.

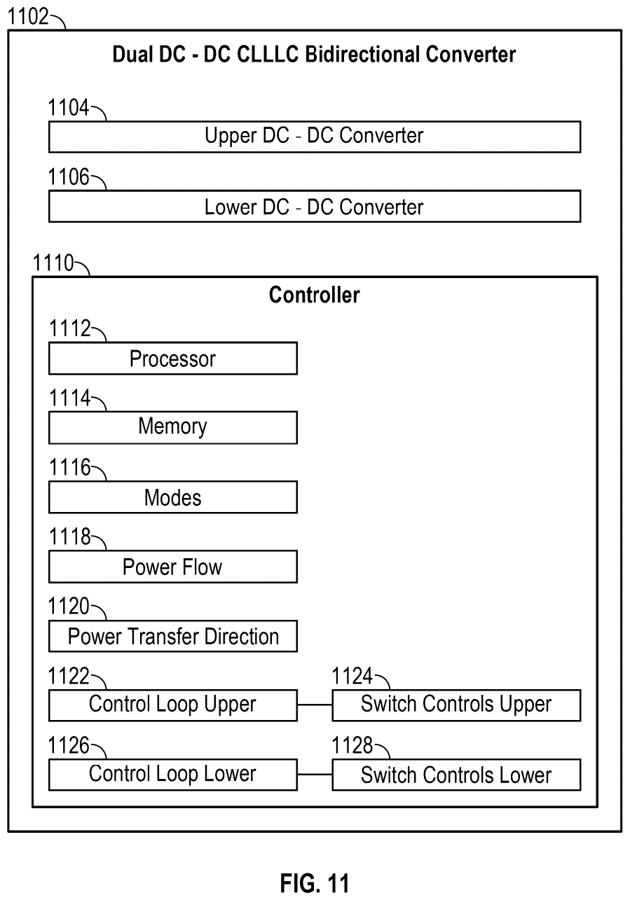

FIG. 11 illustrates a dual DC-DC CLLLC bidirectional converter 1102, in accordance with present embodiments. The converter 1102 has a controller 1110 coupled to the two converters, an upper DC-DC converter 1104 and a lower DC-DC converter 1106. Each of the two, the upper DC-DC converter 1104 and the lower DC-DC converter 1106, is a DC-DC CLLLC bidirectional converter, such as described herein, for example as illustrated in FIG. 3, or variation thereof. The controller 1110, which could be implemented in software executing on a processor, firmware, hardware, or combinations thereof, has the functionality of operating the upper DC-DC converter 1104 and the lower DC-DC converter 1106, including operating the switches with appropriate signaling and waveforms, enabling and disabling, directing power flow and power transfer direction, and various operating modes.

In order to do so and have such functionality and capabilities, the controller 1110 in one embodiment has a processor 1112, memory 1114, and various modules implemented as above. The modes module 1116 determines, selects and operates in various modes such as both converters 1104, 1106 enabled, one converter enabled and the other converter disabled, HV pack balancing mode, bus or capacitor precharge mode, LV battery charge mode, etc. The power flow module 1118 determines power flow in the system, for example based on which mode(s) are active, user input, batteries status (e.g., charge, voltage, charging active or inactive), etc. The power transfer direction module 1120 determines the direction of power transfer in each of the upper DC-DC converter 1104 and the lower DC-DC converter 1106, for example, respecting that each of these is bidirectional and there are various modes and power transfer directions. The control loop upper module 1122 is coupled to the switch controls upper module 1124, and these modules implement the control loop architecture of FIG. 5 and switch controls including signaling and waveforms, for the upper DC-DC converter 1104, for example as described with reference to FIGS. 4, 6 and 7. Similarly, the control loop lower module 1126 and switch controls lower module 1128 implement the control loop architecture of FIG. 5 and switch controls, for the lower DC-DC converter 1106. It is understood each group of controls and converter, one upper, one lower, can operate independently of the other, and has its own control variables for power transfer, such as phase angle, switching frequency, etc.

Capabilities of various embodiments include the system determining whether to balance one HV pack of a split pack HV battery, selecting which HV pack to balance, and controlling power flow and power transfer direction along with switching control for the converters 1104, 1106 to do so. The system can determine whether or when to charge the LV battery, and whether this should be sourced power from one or both HV packs of a split HV pack, then controlling power flow and power transfer direction along with switching control for the converters 1104, 1106 to do so. The system can determine whether or when to precharge the LV bus, precharge the HV bus or HV bus capacitor, and whether this should be sourced power from the LV battery, one or both of the HV packs of a split pack HV battery, then control power flow and power transfer direction along with switching control for the converters 1104, 1106 to do so. Further capabilities as described herein may be included in various embodiments.

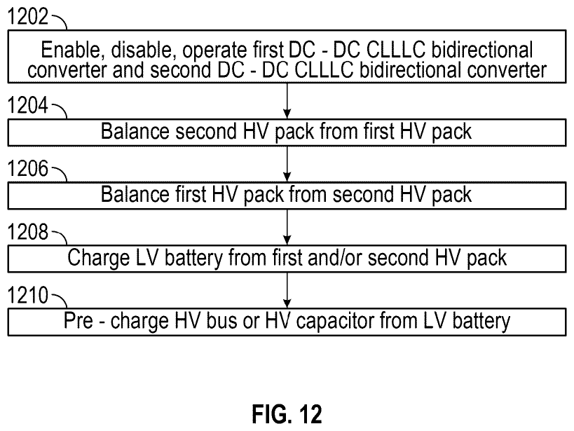

FIG. 12 is a flow diagram illustrating a method of operation of a dual DC-DC CLLLC bidirectional converter, in accordance with present embodiments. The method can be practiced on or by embodiments of a dual DC-DC CLLLC bidirectional converter. The method can be practiced by a processor, for example a processor of a controller, more specifically a processor of a controller in a dual DC-DC CLLLC bidirectional converter. The method can be embodied in instructions in a tangible, non-transitory, computer heaven readable media, for execution by a processor.

The action 1202 is enable, disable and operate a first DC-DC CLLLC bidirectional converter and a second DC-DC CLLLC bidirectional converter. Action 1202 is performed through a controller, with switch controls, power flow and power transfer direction. The first DC-DC CLLLC bidirectional converter is connected to a first HV pack of a split HV pack, and connected to a low voltage battery. The second DC-DC CLLLC bidirectional converter is connected to a second HV pack of the split HV pack, and connected to the same LV battery.

The action 1204 is balance the second HV pack from the first HV pack. Action 1204 is performed through the controller operating the first and second DC-DC CLLLC bidirectional converters.

The action 1206 is balance the first HV pack from the second HV pack. Action 1206 is performed through the controller operating the first and second DC-DC CLLLC bidirectional converters.

The action 1208 is charge the LV battery from the first and/or second HV pack. Action 1208 is performed through the controller operating the first, second, or first and second DC-DC CLLLC bidirectional converters.

The action 1210 is pre-charge the HV bus or the HV capacitor from the LV battery. Action 1210 is performed through the controller operating the first, second, or first and second DC-DC CLLLC bidirectional converters.

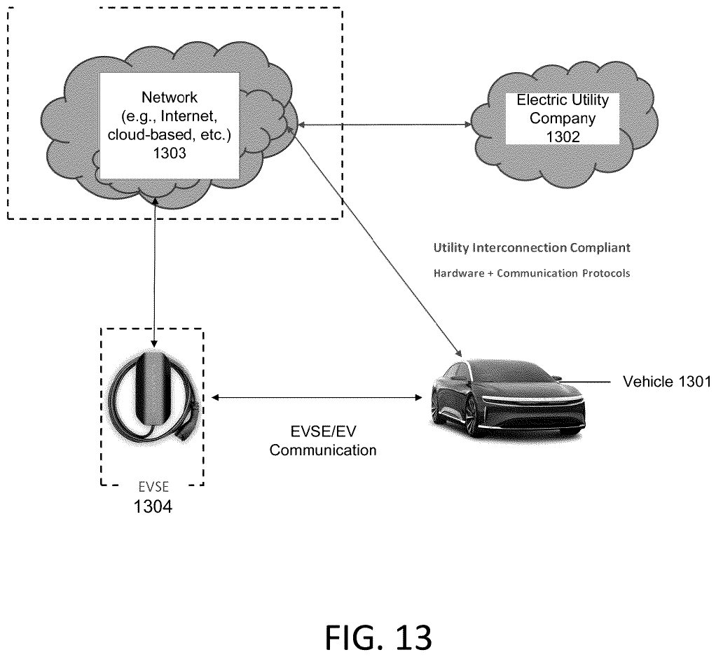

As set forth herein, in some embodiments, the single-stage DC/DC DAB converter transfers power from DC to AC, such as, for example, in the case of transferring power from the vehicle to the grid. FIG. 13 illustrates some embodiments of a communication framework for an electric vehicle (EV) to communicate with an electric utility company in compliance with the electric utility interconnection requirements related to vehicle-to-grid energy transfers.

Referring to FIG. 13, a mobile vehicle 1301 and an electric utility 1302 are communicably coupled to a network 1303. In some embodiments, the communications between mobile vehicle 1301 and electric utility company 1302 are sent through network 1303. Network 1303 can include a cloud-based communication network (e.g., cloud-based communications).

In some embodiments, mobile vehicle 1301 comprises an EV. In some embodiments, mobile vehicle 1301 includes energy storage (e.g., one or more batteries, a battery pack, etc.), a charging port electrically coupled to the energy storage to transfer power to and from the energy storage, an inverter to generate voltage to be sent into an electrical power grid, on-board communication hardware and protocols, and one or more processors. The processor(s) exchange communications with electric utility company 1302, using the communication hardware and according to interoperability requirements of electric utility company 1302. Because the communications meet the interoperability requirements of electric utility company 1302, the communication hardware and protocols of mobile vehicle 1301 are considered utility interconnection compliant. In some embodiments, the communications related to the interoperability requirements occur between the communication hardware and the electric utility company without going through the charging port.

In some embodiments, the communications with electric utility company 1302 and mobile vehicle 1301 are related to discharging voltage from the EV's energy storage to the electrical power grid. That is, mobile vehicle 1301 operates as an energy storage system that has vehicle-to-grid capability to discharge energy into the electrical power grid (i.e., grid discharge capability).

In some embodiments, mobile vehicle 1301 has an inverter to support the vehicle-to-grid capability to discharge energy into the electrical power grid. As mobile vehicle 1301 moves to different portions of the electrical power grid, its inverter becomes a mobile inverter that is able to provide power to those different portions of the grid. In some embodiments, the communications with electric utility company 1302 include inverter settings associated with the inverter of mobile vehicle 1301. The inverter settings can be site specific based on the portion of the electrical grid to which mobile vehicle 1301 is connected. In some embodiments, the communications with electric utility company 1302 meet utility interconnection requirements for stationary inverter based generation via the IEEE 1547-2018 Standard. In some embodiments, the inverter settings for the stationary inverter are the optimal settings as per the IEEE 1547-2018 Standard. In some embodiments, the inverter settings are given during an interconnection approval process, but can change during operation. Such a change can be due to an interconnection agreement.

In some embodiments, the communication hardware and protocols used by mobile vehicle 1301 to meet the interconnection requirements of the electric utility comprise a communication gateway and a communication physical layer. In some embodiments, the communication physical layer comprises an Ethernet communication system layer with an Ethernet interface and communications related to the interoperability requirements occur via the Ethernet interface. In some embodiments, the Ethernet communication system comprises an Ethernet Ring that transfers communications related to vehicle-to-grid operations according to the interoperability requirements of the electric utility company as well as communications related to other non-vehicle-to-grid related communications of the EV. In some embodiments, the non-vehicle-to-grid related communications comprise communications related to one or more subsystems of mobile vehicle 1301, such as, for example, a driver-assistance system of mobile vehicle 1301.

In some embodiments, mobile vehicle 1301 is charged using a charger, such as by EVSE 1304. In some embodiments, the energy storage (e.g., batteries, etc.) of mobile device 1301 can be charged when EVSE 1304 is plugged into, or otherwise electrically connected to, the charging port of mobile vehicle 1301. In some embodiments, when EVSE 1304 is plugged into, or otherwise electrically connected to, the charging port of mobile device 1301, EV communications with the charger occur. These communications can determine the amount of power a charger can provide and can includes requests for an amount of power to be provided to mobile vehicle 1301. In some embodiments, these communications occur over a HomePlug Green-PHY Power Line Carrier. Note that any communications between EVSE 1304 and mobile vehicle 1301 are not related to the vehicle-to-grid discharging power (current) from the EV's energy storage to the electrical power grid and they are not associated with the interoperability requirements of the electric utility company related to that capability.

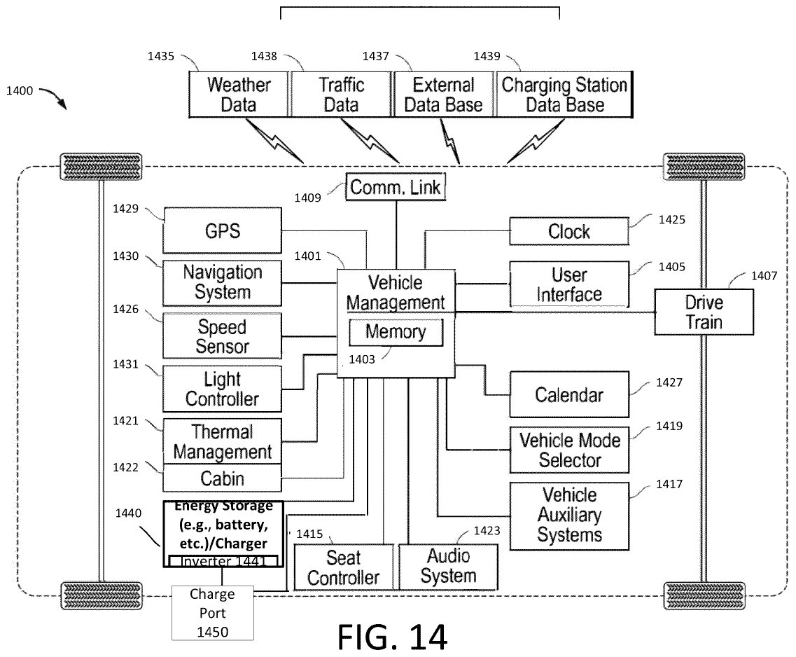

FIG. 14 is a high-level view of some embodiments of a vehicle 1400. Vehicle 1400 can be an electric vehicle (EV), a vehicle utilizing an internal combustion engine (ICE), or a hybrid vehicle, where a hybrid vehicle utilizes multiple sources of propulsion including an electric drive system. Vehicle 1400 includes a vehicle on-board system controller 1401, also referred to herein as a vehicle management system, which is comprised of one or more processors (e.g., a central processing unit (CPU)). System controller 1401 also includes memory 1403, with memory 1403 being comprised of EPROM, EEPROM, flash memory, RAM, solid state drive, hard disk drive, or any other type of memory or combination of memory types.

In some embodiments, vehicle 1400 includes one or more internal networks by which system controller 1401 interfaces and communicates with one or more internal subsystems of vehicle 1400. System controller 1401 can also use the one or more internal networks to transfer communications to and from external locations. In some embodiments, the one or more internal networks can be communicably coupled to one or more networks through a network interface. The network interface can provide for wired and/or wireless communication. When used in a local area networking environment (or a wide area networking environment), the network interface can include an Ethernet interface and the one or more internal networks includes an Ethernet communication network (e.g., an Ethernet Ring, etc.) with an Ethernet Port. Other possible embodiments use other communication devices. For example, in some embodiments vehicle 1400 includes a modem for communicating across an internal network and/or with an external network.

In some embodiments, vehicle 1400 includes a charging port 1450 and one or more batteries (e.g., battery pack, etc.)/battery charger as an energy storage system 1440 that provides power to portions of vehicle 1400. The charging port 1450 is used for providing voltage to vehicle 1400 for charging the energy storage system 1440 (e.g., charging batteries of batteries/charger by the use of, for example, an EVSE or other power source in a manner well-known in the art. The charging port 1450 can be used to transfer power from a battery of the energy storage system 1440 to an external location as part of a vehicle-to-grid power transfer. In some embodiments, charging port 1450 includes a communication path for communications between the system controller 1401 and the locations external to vehicle 1400 such as, for example, the power source providing power (voltage) to vehicle 1400 for charging batteries of the energy storage system 1440 and a utility distributed energy resource management system (DERMS) or an electric utility company and its facilities.

In some embodiments, energy storage system 1440 includes an inverter that generates voltage for transfer to an electric power grid. In some embodiments, the inverter converts DC voltage to AC voltage for transfer to the electric power grid. In some embodiments, the same inverter (or a separate invertor) converts DC voltage to AC voltage for charging a battery of the energy storage system 1440 or can provide DC to AC voltage conversion when providing power to an electrical power grid as part of a vehicle-to-grid operation.

In some embodiments, vehicle 1300 includes a user interface 1405 is coupled to vehicle management system 1401. Interface 1405 allows the driver, or a passenger, to interact with the vehicle management system, for example inputting data into the navigation system 1430, altering the heating, ventilation and air conditioning (HVAC) system via the thermal management system 1421, controlling the vehicle's entertainment system (e.g., radio, CD/DVD player, etc.), adjusting vehicle settings (e.g., seat positions, light controls, etc.), and/or otherwise altering the functionality of vehicle 1400. In some embodiments, user interface 1405 also includes means for the vehicle management system to provide information to the driver and/or passenger, information such as a navigation map or driving instructions (e.g., via the navigation system 1430 and GPS system 1429) as well as the operating performance of any of a variety of vehicle systems (e.g., battery pack charge level for an EV, fuel level for an ICE-based or hybrid vehicle, selected gear, current entertainment system settings such as volume level and selected track information, external light settings, current vehicle speed (e.g., via speed sensor 1426), current HVAC settings such as cabin temperature and/or fan settings, etc.) via the thermal management system 1421. Interface 1405 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). Vehicle 1400 can also include other features like an internal clock 1425 and a calendar 1427.

In some embodiments, user interface 1405 includes one or more interfaces including, for example, a front dashboard display (e.g., a cockpit display, etc.), a touch-screen display (e.g., a pilot panel, etc.), as well as a combination of various other user interfaces such as push-button switches, capacitive controls, capacitive switches, slide or toggle switches, gauges, display screens, warning lights, audible warning signals, etc. It should be appreciated that if user interface 1405 includes a graphical display, controller 1401 may also include a graphical processing unit (GPU), with the GPU being either separate from or contained on the same chip set as the processor.

Vehicle 1400 also includes a drive train 1407 that can include an internal combustion engine, one or more motors, or a combination of both. The vehicle's drive system can be mechanically coupled to the front axle/wheels, the rear axle/wheels, or both, and may utilize any of a variety of transmission types (e.g., single speed, multi-speed) and differential types (e.g., open, locked, limited slip).

Drivers often alter various vehicle settings, either when they first enter the car or while driving, in order to vary the car to match their physical characteristics, their driving style and/or their environmental preferences. System controller 1401 monitors various vehicle functions that the driver may use to enhance the fit of the car to their own physical characteristics, such as seat position (e.g., seat position, seat height, seatback incline, lumbar support, seat cushion angle and seat cushion length) using seat controller 1415 and steering wheel position using an auxiliary vehicle system controller 1417. In some embodiments, system controller 1401 also can monitor a driving mode selector 1419 which is used to control performance characteristics of the vehicle (e.g., economy, sport, normal). In some embodiments, system controller 1401 can also monitor suspension characteristics using auxiliary vehicle system 1417, assuming that the suspension is user adjustable. In some embodiments, system controller 1401 also monitors those aspects of the vehicle which are often varied by the user in order to match his or her environmental preferences for the cabin 1422, for example setting the thermostat temperature or the recirculation controls of the thermal management system 1421 that uses an HVAC controller, and/or setting the radio station/volume level of the audio system using controller 1423, and/or setting the lights, either internal lighting or external lighting, using light controller 1431. Also, besides using user-input and on-board sensors, system controller 1401 can also use data received from an external on-line source that is coupled to the controller via communication link 1409 (using, for example, GSM, EDGE, UMTS, CDMA, DECT, WiFi, WiMax, etc.). For example, in some embodiments, system controller 1401 can receive weather information using an on-line weather service 1435 or an on-line data base 1437, traffic data 1438 for traffic conditions for the navigation system 1430, charging station locations from a charging station database 1439, etc. In some embodiments, communication link 1409 comprises an Ethernet communication link with an Ethernet Port for external communications.

The system controller 1401 can transfer information with the components described above over one or more internal networks, such as those, for example, described above. In some embodiments, the system controller 1401 is communicably coupled to one or more of these components via an Ethernet communication network (e.g., an Ethernet Ring, etc.). The Ethernet communication network can be used to transfer other data such as data related to, but not limited to, one or more of a driver-assistance system, telematics, over-the-air updates, etc.

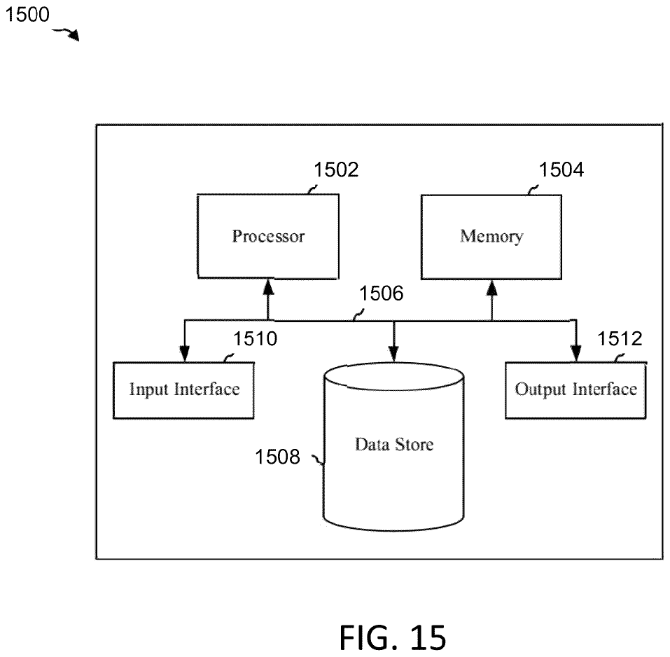

FIG. 15 is a high-level illustration of an exemplary computing device 1500 that can be used in accordance with the systems and methodologies disclosed herein. For instance, the computing device 1500 may be or include the vehicle 1400 of FIG. 14. The computing device 1500 includes at least one processor 1502 that executes instructions that are stored in a memory 1504. The instructions may be, for instance, instructions for implementing functionality described as being carried out by one or more modules or instructions for implementing one or more of the methods described above. The processor 1502 may access the memory 1504 by way of a system bus 1506.

The computing device 1500 additionally includes a data store 1508 that is accessible by the processor 1502 by way of the system bus 1506. The data store 1508 may include executable instructions and the like. The computing device 1500 also includes an input interface 1510 that allows external devices to communicate with the computing device 1500. For instance, the input interface 1510 may be used to receive instructions from an external computing device, from a user, etc. The computing device 1500 also includes an output interface 1512 that interfaces the computing device 1500 with one or more external devices. In some embodiment, the input interface 1510 and the output interface 1512 can be used to communicate to an electric utility company (e.g., a utility distributed energy resource management system (DERMS) or server, etc.). These communications can relate to vehicle-to-grid operations and/or standards as described above. In some embodiment, the input interface 1510 and the output interface 1512 are part of, or communicably coupled to, an Ethernet port of an Ethernet communication network (e.g., an Ethernet Ring, etc.).

Additionally, while illustrated as a single system, it is to be understood that the computing device 1500 may be a distributed system. Thus, for instance, several devices may be in communication by way of a network connection and may collectively perform tasks described as being performed by the computing device 1500.

There is a number of example embodiments described herein.

Example 1 is a dual DC-DC CLLLC bidirectional converter, including a first DC-DC CLLLC bidirectional converter, connectable to a first high voltage (HV) pack of a split HV pack and connectable to a low voltage (LV) battery and a second DC-DC CLLLC bidirectional converter, connectable to a second HV pack of the split HV pack and connectable to the LV battery. The dual DC-DC CLLLC bidirectional converter also includes a controller, to enable, disable, and operate each of the first DC-DC CLLLC bidirectional converter and the second DC-DC CLLLC bidirectional converter, with switch controls, power flow and power transfer direction, in a plurality of modes including: balancing the second HV pack from the first HV pack through the first DC-DC CLLLC bidirectional converter and the second DC-DC CLLLC bidirectional converter; balancing the first HV pack from the second HV pack through the second DC-DC CLLLC bidirectional converter and the first DC-DC CLLLC bidirectional converter; charging the LV battery from the first HV pack through the first DC-DC CLLLC bidirectional converter, from the second HV pack through the second DC-DC CLLLC bidirectional converter, or from the first and second HV packs through the first and second DC-DC CLLLC bidirectional converters; and pre-charging an HV bus or an HV capacitor from the LV battery through the first DC-DC CLLLC bidirectional converter, through the second DC-DC CLLLC bidirectional converter, or through the first and second DC-DC CLLLC bidirectional converters.

Example 2 is the dual DC-DC CLLLC bidirectional converter of example 1 that may optionally include that the controller is operable to enable and disable each of the first and second DC-DC CLLLC bidirectional converters based on loading conditions.

Example 3 is the dual DC-DC CLLLC bidirectional converter of example 1 that may optionally include that the controller is operable to regulate switching frequency and phase shift to achieve required power transfer, in operating each of the first DC-DC CLLLC bidirectional converter and the second DC-DC CLLLC bidirectional converter with the switch controls, power flow and power transfer direction.

Example 4 is the dual DC-DC CLLLC bidirectional converter of example 1 that may optionally include an HV side of each of the first and second DC-DC CLLLC bidirectional converters having a half-bridge configuration; an LV side of each of the first and second DC-DC CLLLC bidirectional converters having a full-bridge configuration; and wherein the controller is operable to have the switch controls have duty cycle of HV side switches and LV side switches, of each of the first and second DC-DC CLLLC bidirectional converters, at 0.5, using a unipolar voltage pulse on the HV side and a bipolar voltage pulse on the LV side.

Example 5 is the dual DC-DC CLLLC bidirectional converter of example 1 that may optionally include that the controller is operable to regulate switching frequency and phase shift to have zero voltage switching (ZVS) turn-on across all switches of first and second DC-DC CLLLC bidirectional converters.

Example 6 is the dual DC-DC CLLLC bidirectional converter of example 1 that may optionally include that the controller is operable to regulate switching frequency of the switch controls of each of the first and second DC-DC CLLLC bidirectional converters to within a specified range of normalized frequency 1.2-1.8.

Example 7 is the dual DC-DC CLLLC bidirectional converter of example 1 that may optionally include that the controller is operable to regulate switching frequency of the switch controls of each of the first and second DC-DC CLLLC bidirectional converters to decrease the switching frequency for increased output power, and increase the switching frequency for decreased output power.

Example 8 is a method of operating a dual DC-DC CLLLC bidirectional converter, wherein the method includes: enabling, disabling, and operating each of a first DC-DC CLLLC bidirectional converter connected to a first high voltage (HV) pack of a split HV pack and connected to a low voltage (LV) battery, and a second DC-DC CLLLC bidirectional converter connected to a second HV pack of the split HV pack and connected to the LV battery, through a controller, with switch controls, power flow and power transfer direction; balancing the second HV pack from the first HV pack through the controller operating the first DC-DC CLLLC bidirectional converter and the second DC-DC CLLLC bidirectional converter; balancing the first HV pack from the second HV pack through the controller operating the second DC-DC CLLLC bidirectional converter and the first DC-DC CLLLC bidirectional converter; charging the LV battery from the first HV pack through the controller operating the first DC-DC CLLLC bidirectional converter, from the second HV pack through the controller operating the second DC-DC CLLLC bidirectional converter, or from the first and second HV packs through the controller operating the first and second DC-DC CLLLC bidirectional converters; and pre-charging an HV bus or an HV capacitor from the LV battery through the controller operating the first DC-DC CLLLC bidirectional converter, through the controller operating the second DC-DC CLLLC bidirectional converter, or through the controller operating the first and second DC-DC CLLLC bidirectional converters.

Example 9 is the method of operating the dual DC-DC CLLLC bidirectional converter of example 8 that may optionally include enabling and disabling, through the controller, each of the first and second DC-DC CLLLC bidirectional converters based on loading conditions.

Example 10 is the method of operating the dual DC-DC CLLLC bidirectional converter of example 8 that may optionally include regulating, through the controller, switching frequency and phase shift to achieve required power transfer, in operating each of the first DC-DC CLLLC bidirectional converter and the second DC-DC CLLLC bidirectional converter with the switch controls, power flow and power transfer direction.

Example 11 is the method of operating the dual DC-DC CLLLC bidirectional converter of example 8 that may optionally include operating, through the controller, the switch controls to have duty cycle of HV side switches and LV side switches, of each of the first and second DC-DC CLLLC bidirectional converters, at 0.5, using a unipolar voltage pulse on the HV side and a bipolar voltage pulse on the LV side, wherein an HV side of each of the first and second DC-DC CLLLC bidirectional converters has a half-bridge configuration and an LV side of each of the first and second DC-DC CLLLC bidirectional converters has a full-bridge configuration.

Example 12 is the method of operating the dual DC-DC CLLLC bidirectional converter of example 8 that may optionally include regulating, through the controller, switching frequency and phase shift to have zero voltage switching (ZVS) turn-on across all switches of first and second DC-DC CLLLC bidirectional converters.

Example 13 is the method of operating the dual DC-DC CLLLC bidirectional converter of example 8 that may optionally include regulating, through the controller, switching frequency of the switch controls of each of the first and second DC-DC CLLLC bidirectional converters to within a specified range of normalized frequency 1.2-1.8.

Example 14 is the method of operating the dual DC-DC CLLLC bidirectional converter of example 8 that may optionally include regulating, through the controller, switching frequency of the switch controls of each of the first and second DC-DC CLLLC bidirectional converters to decrease the switching frequency for increased output power, and increase the switching frequency for decreased output power.

Example 15 is a tangible, non-transitory, computer-readable media having instructions thereupon which, when executed by a processor, cause the processor to perform a method that includes: enabling, disabling, and operating each of a first DC-DC CLLLC bidirectional converter, of a dual DC-DC CLLLC bidirectional converter, connected to a first high voltage (HV) pack of a split HV pack and connected to a low voltage (LV) battery, and a second DC-DC CLLLC bidirectional converter, of the dual DC-DC CLLLC bidirectional converter, connected to a second HV pack of the split HV pack and connected to the LV battery, through a controller, with switch controls, power flow and power transfer direction; balancing the second HV pack from the first HV pack through the controller operating the first DC-DC CLLLC bidirectional converter and the second DC-DC CLLLC bidirectional converter; balancing the first HV pack from the second HV pack through the controller operating the second DC-DC CLLLC bidirectional converter and the first DC-DC CLLLC bidirectional converter; charging the LV battery from the first HV pack through the controller operating the first DC-DC CLLLC bidirectional converter, from the second HV pack through the controller operating the second DC-DC CLLLC bidirectional converter, or from the first and second HV packs through the controller operating the first and second DC-DC CLLLC bidirectional converters; pre-charging an HV bus or an HV capacitor from the LV battery through the controller operating the first DC-DC CLLLC bidirectional converter, through the controller operating the second DC-DC CLLLC bidirectional converter, or through the controller operating the first and second DC-DC CLLLC bidirectional converters; and enabling and disabling, through the controller, each of the first and second DC-DC CLLLC bidirectional converters based on loading conditions.

Example 16 is the tangible, non-transitory, computer-readable media of example 15 wherein the method may optionally include regulating, through the controller, switching frequency and phase shift to achieve required power transfer, in operating each of the first DC-DC CLLLC bidirectional converter and the second DC-DC CLLLC bidirectional converter with the switch controls, power flow and power transfer direction.

Example 17 is the tangible, non-transitory, computer-readable media of example 15 wherein the method may optionally include operating, through the controller, the switch controls to have duty cycle of HV side switches and LV side switches, of each of the first and second DC-DC CLLLC bidirectional converters, at 0.5, using a unipolar voltage pulse on the HV side and a bipolar voltage pulse on the LV side, wherein an HV side of each of the first and second DC-DC CLLLC bidirectional converters has a half-bridge configuration and an LV side of each of the first and second DC-DC CLLLC bidirectional converters has a full-bridge configuration.

Example 18 is the tangible, non-transitory, computer-readable media of example 15 wherein the method may optionally include regulating, through the controller, switching frequency and phase shift to have zero voltage switching (ZVS) turn-on across all switches of first and second DC-DC CLLLC bidirectional converters.

Example 19 is the tangible, non-transitory, computer-readable media of example 15 wherein the method may optionally include regulating, through the controller, switching frequency of the switch controls of each of the first and second DC-DC CLLLC bidirectional converters to within a specified range of normalized frequency 1.2-1.8.

Example 20 is the tangible, non-transitory, computer-readable media of example 15 wherein the method may optionally include regulating, through the controller, switching frequency of the switch controls of each of the first and second DC-DC CLLLC bidirectional converters to decrease the switching frequency for increased output power, and increase the switching frequency for decreased output power.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A dual DC-DC CLLLC bidirectional converter, comprising:
a first DC-DC CLLLC bidirectional converter, connectable to a first high voltage (HV) pack of a split HV pack and connectable to a low voltage (LV) battery;
a second DC-DC CLLLC bidirectional converter, connectable to a second HV pack of the split HV pack and connectable to the LV battery; and
a controller, to enable, disable, and operate each of the first DC-DC CLLLC bidirectional converter and the second DC-DC CLLLC bidirectional converter, with switch controls, power flow and power transfer direction, in a plurality of modes including:
balancing the second HV pack from the first HV pack through the first DC-DC CLLLC bidirectional converter and the second DC-DC CLLLC bidirectional converter;
balancing the first HV pack from the second HV pack through the second DC-DC CLLLC bidirectional converter and the first DC-DC CLLLC bidirectional converter;
charging the LV battery from the first HV pack through the first DC-DC CLLLC bidirectional converter, from the second HV pack through the second DC-DC CLLLC bidirectional converter, or from the first and second HV packs through the first and second DC-DC CLLLC bidirectional converters; and
pre-charging an HV bus or an HV capacitor from the LV battery through the first DC-DC CLLLC bidirectional converter, through the second DC-DC CLLLC bidirectional converter, or through the first and second DC-DC CLLLC bidirectional converters.

2. The dual DC-DC CLLLC bidirectional converter of claim 1, further comprising the controller to:
enable and disable each of the first and second DC-DC CLLLC bidirectional converters based on loading conditions.

3. The dual DC-DC CLLLC bidirectional converter of claim 1, further comprising the controller to:
regulate switching frequency and phase shift to achieve required power transfer, in operating each of the first DC-DC CLLLC bidirectional converter and the second DC-DC CLLLC bidirectional converter with the switch controls, power flow and power transfer direction.

4. The dual DC-DC CLLLC bidirectional converter of claim 1, further comprising:
an HV side of each of the first and second DC-DC CLLLC bidirectional converters having a half-bridge configuration;
an LV side of each of the first and second DC-DC CLLLC bidirectional converters having a full-bridge configuration; and
the controller to have the switch controls have duty cycle of HV side switches and LV side switches, of each of the first and second DC-DC CLLLC bidirectional converters, at 0.5, using a unipolar voltage pulse on the HV side and a bipolar voltage pulse on the LV side.

5. The dual DC-DC CLLLC bidirectional converter of claim 1, further comprising the controller to:
regulate switching frequency and phase shift to have zero voltage switching (ZVS) turn-on across all switches of first and second DC-DC CLLLC bidirectional converters.

6. The dual DC-DC CLLLC bidirectional converter of claim 1, further comprising the controller to:
regulate switching frequency of the switch controls of each of the first and second DC-DC CLLLC bidirectional converters to within a specified range of normalized frequency 1.2-1.8.

7. The dual DC-DC CLLLC bidirectional converter of claim 1, further comprising the controller to:
regulate switching frequency of the switch controls of each of the first and second DC-DC CLLLC bidirectional converters to decrease the switching frequency for increased output power, and increase the switching frequency for decreased output power.

8. A method of operating a dual DC-DC CLLLC bidirectional converter, comprising:
enabling, disabling, and operating each of a first DC-DC CLLLC bidirectional converter connected to a first high voltage (HV) pack of a split HV pack and connected to a low voltage (LV) battery, and a second DC-DC CLLLC bidirectional converter connected to a second HV pack of the split HV pack and connected to the LV battery, through a controller, with switch controls, power flow and power transfer direction;
balancing the second HV pack from the first HV pack through the controller operating the first DC-DC CLLLC bidirectional converter and the second DC-DC CLLLC bidirectional converter;
balancing the first HV pack from the second HV pack through the controller operating the second DC-DC CLLLC bidirectional converter and the first DC-DC CLLLC bidirectional converter;
charging the LV battery from the first HV pack through the controller operating the first DC-DC CLLLC bidirectional converter, from the second HV pack through the controller operating the second DC-DC CLLLC bidirectional converter, or from the first and second HV packs through the controller operating the first and second DC-DC CLLLC bidirectional converters; and
pre-charging an HV bus or an HV capacitor from the LV battery through the controller operating the first DC-DC CLLLC bidirectional converter, through the controller operating the second DC-DC CLLLC bidirectional converter, or through the controller operating the first and second DC-DC CLLLC bidirectional converters.

9. The method of operating the dual DC-DC CLLLC bidirectional converter of claim 8, further comprising:
enabling and disabling, through the controller, each of the first and second DC-DC CLLLC bidirectional converters based on loading conditions.

10. The method of operating the dual DC-DC CLLLC bidirectional converter of claim 8, further comprising:
regulating, through the controller, switching frequency and phase shift to achieve required power transfer, in operating each of the first DC-DC CLLLC bidirectional converter and the second DC-DC CLLLC bidirectional converter with the switch controls, power flow and power transfer direction.

11. The method of operating the dual DC-DC CLLLC bidirectional converter of claim 8, further comprising:
operating, through the controller, the switch controls to have duty cycle of HV side switches and LV side switches, of each of the first and second DC-DC CLLLC bidirectional converters, at 0.5, using a unipolar voltage pulse on the HV side and a bipolar voltage pulse on the LV side, wherein:
an HV side of each of the first and second DC-DC CLLLC bidirectional converters has a half-bridge configuration; and
an LV side of each of the first and second DC-DC CLLLC bidirectional converters has a full-bridge configuration.

12. The method of operating the dual DC-DC CLLLC bidirectional converter of claim 8, further comprising:
regulating, through the controller, switching frequency and phase shift to have zero voltage switching (ZVS) turn-on across all switches of first and second DC-DC CLLLC bidirectional converters.

13. The method of operating the dual DC-DC CLLLC bidirectional converter of claim 8, further comprising:
regulating, through the controller, switching frequency of the switch controls of each of the first and second DC-DC CLLLC bidirectional converters to within a specified range of normalized frequency 1.2-1.8.

14. The method of operating the dual DC-DC CLLLC bidirectional converter of claim 8, further comprising:
regulating, through the controller, switching frequency of the switch controls of each of the first and second DC-DC CLLLC bidirectional converters to decrease the switching frequency for increased output power, and increase the switching frequency for decreased output power.

15. A tangible, non-transitory, computer-readable media having instructions thereupon which, when executed by a processor, cause the processor to perform a method comprising:
enabling, disabling, and operating each of a first DC-DC CLLLC bidirectional converter, of a dual DC-DC CLLLC bidirectional converter, connected to a first high voltage (HV) pack of a split HV pack and connected to a low voltage (LV) battery, and a second DC-DC CLLLC bidirectional converter, of the dual DC-DC CLLLC bidirectional converter, connected to a second HV pack of the split HV pack and connected to the LV battery, through a controller, with switch controls, power flow and power transfer direction;
balancing the second HV pack from the first HV pack through the controller operating the first DC-DC CLLLC bidirectional converter and the second DC-DC CLLLC bidirectional converter;
balancing the first HV pack from the second HV pack through the controller operating the second DC-DC CLLLC bidirectional converter and the first DC-DC CLLLC bidirectional converter;
charging the LV battery from the first HV pack through the controller operating the first DC-DC CLLLC bidirectional converter, from the second HV pack through the controller operating the second DC-DC CLLLC bidirectional converter, or from the first and second HV packs through the controller operating the first and second DC-DC CLLLC bidirectional converters;
pre-charging an HV bus or an HV capacitor from the LV battery through the controller operating the first DC-DC CLLLC bidirectional converter, through the controller operating the second DC-DC CLLLC bidirectional converter, or through the controller operating the first and second DC-DC CLLLC bidirectional converters; and
enabling and disabling, through the controller, each of the first and second DC-DC CLLLC bidirectional converters based on loading conditions.

16. The tangible, non-transitory, computer-readable media of claim 15, wherein the method further comprises:
regulating, through the controller, switching frequency and phase shift to achieve required power transfer, in operating each of the first DC-DC CLLLC bidirectional converter and the second DC-DC CLLLC bidirectional converter with the switch controls, power flow and power transfer direction.

17. The tangible, non-transitory, computer-readable media of claim 15, wherein the method further comprises:
operating, through the controller, the switch controls to have duty cycle of HV side switches and LV side switches, of each of the first and second DC-DC CLLLC bidirectional converters, at 0.5, using a unipolar voltage pulse on the HV side and a bipolar voltage pulse on the LV side, wherein:
an HV side of each of the first and second DC-DC CLLLC bidirectional converters has a half-bridge configuration; and
an LV side of each of the first and second DC-DC CLLLC bidirectional converters has a full-bridge configuration.

18. The tangible, non-transitory, computer-readable media of claim 15, wherein the method further comprises:
regulating, through the controller, switching frequency and phase shift to have zero voltage switching (ZVS) turn-on across all switches of first and second DC-DC CLLLC bidirectional converters.

19. The tangible, non-transitory, computer-readable media of claim 15, wherein the method further comprises:
regulating, through the controller, switching frequency of the switch controls of each of the first and second DC-DC CLLLC bidirectional converters to within a specified range of normalized frequency 1.2-1.8.

20. The tangible, non-transitory, computer-readable media of claim 15, wherein the method further comprises:
regulating, through the controller, switching frequency of the switch controls of each of the first and second DC-DC CLLLC bidirectional converters to decrease the switching frequency for increased output power, and increase the switching frequency for decreased output power.
